(19) United States
(12) Patent Application Publication
(10) Pub. No.: US 2009/0083541 A1
(43) Pub. Date: Mar. 26, 2009

(54) METHOD AND APPARATUS FOR DISTRIBUTING DIGITAL CONTENT

(76) Inventor: Scott Levine, New York, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/185,159

(22) Filed: Aug. 4, 2008

Related U.S. Application Data
(60) Provisional application No. 60/953,484, filed on Aug. 2, 2007.

(51) Int. Cl. H04L 9/00; G06F 17/30

(52) U.S. Cl. 713/165; 707/10; 713/176; 713/172; 707/E17.01; 707/E17.032

(57) ABSTRACT

The present invention provides a system in which audio files are distributed that include watermarks, digital signatures and/or encryption. The file may offer content owners some amount of playback control, while offering the consumer value-added content & services, and maintaining backward compatibility to existing digital file players such as MP3 players. By enticing the consumer with value-added content and services alongside the purchased songs, the consumer is encouraged to obtain these files from participating retailers and to replay the files using compliant players.

### RELATED APPLICATIONS

This application claims priority to U.S. Provisional application Ser. No. 60/953,484 filed Aug. 2, 2007, and incorporated herein in its entirety.

### BACKGROUND OF THE INVENTION

1. Field of Invention

This invention pertains to an apparatus and method for exchanging or distributing files with digital content. The files include a heading that is partially encrypted and includes various information that uniquely identifies the file. Optional data may also be included that enhances or augments the digital content or that allows the user to obtain additional content, goods or services.

2. Description of the Prior Art

Digital content, such as music, is presently available from many different sources in many different formats. One popular format for this purpose is the MP3 format. This format refers to the Audio Layer of MPEG1 (a common video compression standard promulgated by the Motion Pictures Experts Group) and uses well known algorithms for compressing a sound sequence into a very small file (about one-twelfth the size of the original file) while preserving the original level of sound quality when it is played. Distributing music in the MP3 format offers several advantages, such as interoperability among many music devices and online retailers. The processes thus deliver a better experience for the user and potentially increase the market size for selling digital content.

However selling music in the standard MP3 format also has several disadvantages, such as:
1. Lack of copy protection functionality or any other playback control mechanism for the content provider.
2. Lack of a robust method to identify which consumer purchased a particular MP3 file. Even if a purchaser's ID, such as his email address is included in the file (e.g., the MP3 header), the file can still be easily changed since this information is not protected.
3. A purchaser or consumer has no way of knowing that an MP3 file is authentic and of high quality, as opposed to being poorly ripped from an illegitimate source.
4. There is no robust method to assert the copyright of the content and to enable content filtering.

### SUMMARY OF THE INVENTION

The present invention provides a system for distributing audio files. As part of this system, a new type of digital file is presented, which is hereinafter referred to as an SB3 file, that is backward compatible with all current MP3 players, and uses the same data compression and header format as standard MP3 files. Alternatively, the SB3 file can incorporate content in other well known digital audio formats, such as the MPEG-AAC format. The SB3 files in this format may offer value-added content and services (“VACS”) to the consumer. In addition the files may optionally offer playback control to the content owners through a combination of watermarks, digital signatures and encryption. When consumers purchase new SB3 audio files, they may receive VACS that can be played on respective compliant media players that follow a set of playback control rules. The goal is to offer (by creating, partnering, or acquiring) VACS so compelling that consumers will choose to switch from non-compliant MP3 players.

More particularly, the subject application pertains to a method and apparatus for distributing digital files to users from a server using a distributed network. The apparatus and method provide a digital file including digital content and a header. The header is partitioned into two portions, a cleartext portion and an encrypted portion. The header includes information uniquely identifying the digital file. For example, in one embodiment, the header includes information about a respective user of the digital file. The header may also include information about the content, the content provider, the reseller, details of the transaction by which the digital file has been acquired, etc. This digital file is transmitted over the distributed network to a user.

The user preferably has a compliant player that checks the received digital file for a header. If a header is found, further processing takes place. If no header is found, in one embodiment, the player assumes that a legacy file has been received (i.e., a noncompliant file) and the file is stored or presented to the user as required. In another embodiment, a watermark is embedded in the file, for example in the digital content. The watermark is used to confirm that the header of the file (if any) is genuine.

Additional materials (including content, goods and services) may be provided that are identified by a token, a link or other means. The additional materials may augment the content or may include promotional goods or services. The user can keep the content and the additional information and/or may share it with others depending on the rules set by the provider of the additional materials.

The goods and services may be provided in a message or a special link may be provided to one or more websites that source additional content. Alternatively, the link or token may trigger a message from a compliant player that includes a request for additional materials and the server can point the request to a content provider or other sources. The additional content is sent to the requesting compliant player.

In one aspect of the invention, a user purchases the file and the file provider (e.g., a retailer or content provider) then generates the file including therein a header that incorporates therein one or more data fields such transactional data and/or other information associated with the user, such as user ID or his e-mail. At least a portion of the header is encrypted. Some of the data fields may be incorporated in both the encrypted and the plaintext portions of the header.

When the user receives the digital file, his compliant player checks for the header and the watermark and uses the same for authentication. If no header or watermark is detected, the file is presented as a standard or conventional content file.

In another aspect of the invention, the present application provides a method and apparatus for distributing digital content files in which a digital file including digital content and a header is provided. The header is partitioned into two portions, a cleartext portion and an encrypted portion, that includes information identifying a respective user of said digital file and a link identifying a content source. The digital file is transmitted over said distributed network to one of said users. Once the digital file is received, it can be stored or played at will. In addition, the digital file is shared by other similar users. The header includes a link that can be used by any of the users to receive additional content, recommendations and so on. The link can be a dynamic and a static link and can lead to a content source that generates a new file or streams the content.

In another aspect of the invention, the link leads to a recommendation server that provides recommendations for new content.

In another aspect of the invention, a method and apparatus are presented for distributing digital content files to users from a server using a distributed network by providing a digital file including digital content and a header, said header partitioned into two portions, a cleartext portion and an encrypted portion, said header including information identifying a respective user of said digital file and a link identifying a content source.

In another aspect of the invention, tokens are provided in the header. The token can be used to obtain additional materials such as various promotional goods and services. The token may be used as part of a customer appreciation program.

### BRIEF DESCRIPTION OF THE DRAWINGS

FIG. 1A shows the components of a prior art digital audio file;

FIG. 1B shows the components of a digital audio file generated in accordance with this invention;

FIG. 1C shows a method used by a retailer for generating the digital file of FIG. 1B;

FIG. 2 shows a method for generating a similar SB3 file from a compliant or non-compliant CD;

FIG. 3 shows a method performed by a compliant player to determine that an SB3 file from a retailer is authentic;

FIG. 3A shows a display screen for a compliant player;

FIG. 4 shows a method performed by a compliant player to determine that an SB3 file from another user is authentic and authorized;

FIG. 5 shows a method of sharing links between users that allow a user to get streamed content;

FIG. 6 shows a method of redeeming tokens or value added content and services in accordance with this invention;

FIG. 7 shows a block diagram of a system with several users receiving and using SB3 digital files in accordance with this invention;

FIG. 7A shows a block diagram of a compliant player constructed in accordance with this invention; and

FIG. 8 shows a process for handling a file with a complex watermark;

### DETAILED DESCRIPTION OF THE INVENTION

As previously discussed, the present invention provides a system for distributing digital files. Each digital file includes a header with an encrypted and a cleartext portion, and digital content that is compressed using either an MP3 compression format, or other well-known formats, such as MPEG-AAC and others. The file is termed here an SB3 file, and as shall be described in more detail below, it is backwardly compatible with conventional or legacy players (such as MP3 players). Optionally, the SB3 files may offer value-added content and services (“VACS”). Moreover, optionally, playback control is offered to the content owners through a combination of watermarks, digital signatures and encryption.

Audio Watermarking Overview

An audio watermark is data that is embedded directly within the audio signal itself. The audio watermark is imperceptible by humans, but can be read by computer software. There are many companies that supply audio watermarking technology. The present system can use any audio watermarking, as long as (i) it is not perceptible by listeners, (ii) it is difficult to remove, and (iii) there are enough bits available in the watermark payload for our particular needs.

Presently there are various types of audio watermarks available, which are broadly classified into two groups: static and transactional.

A static watermark is embedded once per master copy, usually by the content owner or provider, before it is sent to an online retailer or CD replicator. A static watermark can include several fields, each field being dedicated to certain information, such as:
Content ID: includes an ISRC, parental control, and assert that it is owned by a distributer. Content filtering applications can search for this watermark to determine if the file is copyrighted.
Product ID: This watermark field identifies if the file was originally sold on a CD, DVD, digital download, digital stream, etc. If such a file were found in an illegitimate channel, the watermark could determine the initial source of the leak.
Retailer ID: This watermark field identifies the name of the retailer (e.g., Amazon, iTunes, Napster) that distributed the file.
SB3 Header Present: This one-bit watermark asserts that an SB3 header should be attached to the audio data. If an audio file was watermarked with this field, but there was no SB3 header present, the header must have been illegitimately stripped, and the audio file should not be played.

A transactional watermark is dynamically generated and embedded by the retailer within an audio file at the time of the sale to the end consumer. Potential transactional watermark fields include one or more of the following:
UserID: A unique ID corresponding to the individual user purchasing the content. Ideally, each end user has a single UserID across all retailers, but this may not be commercially viable. Alternatively, each end user has one UserID for a particular online retailer. In other words, each retailer provides the same user ID to all its purchasers. The UserID may include the user's e-mail address.
Date/Time: The date and time that the user acquired the content.
TransactionID: An ID that uniquely identifies this transaction. A retailer should generate a unique TransactionID for every piece of content it sells. Ideally, TransactionID's would be unique across all retailers, but this may not be commercially viable. Details of the transaction (such as retail price, client software version, IP address, ISRC, UserID, Date/Time) are stored in a database and referenced by the TransactionID.

Of course, other information may be included in the watermark as well.

SB3 File Format:

This section describes the “SB3” format that enables interoperability across all conventional MP3 players. The SB3 format offer users the ability to gain value added content and services, and may offer the content owners a certain amount of content protection.

The additional information can be included in an in-band audio watermark and/or an out-of-band header. The main advantage of placing information in a watermark is that the audio watermark is robust (i.e., it is very difficult for someone to remove the information). The disadvantage is that there are not many bits available to embed robustly and inaudibly in a watermark. In addition, audio watermarking can be expensive from a time, cost and computational perspective, especially if a watermark is embedded in a transactional manner.

On the other hand, it is very simple and inexpensive to include a large amount of information, even in a transactional basis, within a header of an audio file. The disadvantage of a header, as discussed above, is that it is relatively simple for someone to remove the header of an audio file, replace it with a different header, and the resulting audio file will still be playable on any MP3 player.

The SB3 file format includes information relating to the audio file and the transaction (e.g., the end-user, the retailer, the time/date, the name of the song, etc.) in the header file. It also includes a one bit watermark that will signify that a header was originally attached to the file.

One drawback to this design is that in the event that the header of an audio file is removed, the system will not know anything about the transaction (e.g., who purchased the song, when it was purchased, by which retailer, etc.). The system will only know, by evidence of the one-bit watermark, that there once was a header attached.

In other configurations, certain fields are replicated from the header, which also places them in the embedded watermark. For example, the content owner could include a RetailerID watermark and header of each audio file before it is sent to a particular retailer (e.g., Amazon, Apple, etc.). Additionally, a retailer could embed the unique UserID of an end-customer in an audio file just before it is sent to the consumer. Adding this extra information into the watermark will require additional computational resources and expenses, but may be worth the ability to learn more about a file's origin if its header had been illegitimately removed.

File Format Overview:

The SB3 file will store relevant information about the audio file in an SB3 header. The header will be “digitally signed” (a cryptographic method to be described in the following section, Header Security), which will reliably tell the media player client if the SB3 header or audio data has been altered. The audio data within the SB3 file will be embedded with a simple one-bit static watermark, which asserts that the file should have a Compliant SB3 header attached to it. This one-bit static watermark is referred to as the “SB3 Header Present” watermark. If a Compliant media player sees a file with an embedded “SB3 Header Present” watermark but without a SB3 header attached to the file, the player that knows the header has been illegitimately removed, and it will not be played. Certain portions of the SB3 header can only be viewed by compliant players, while other portions of the header can be viewed by all MP3 players.

Header Information:

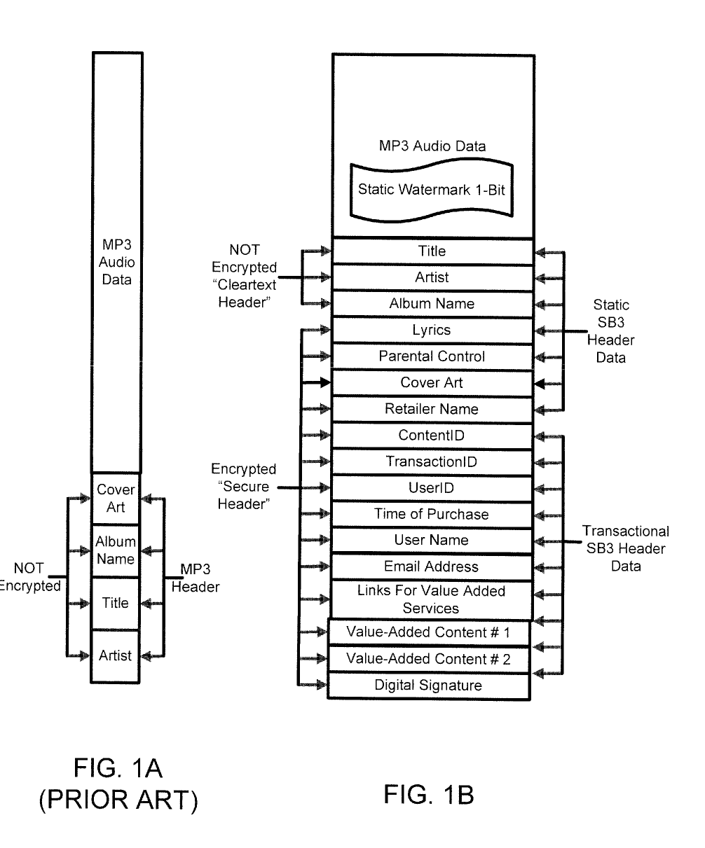

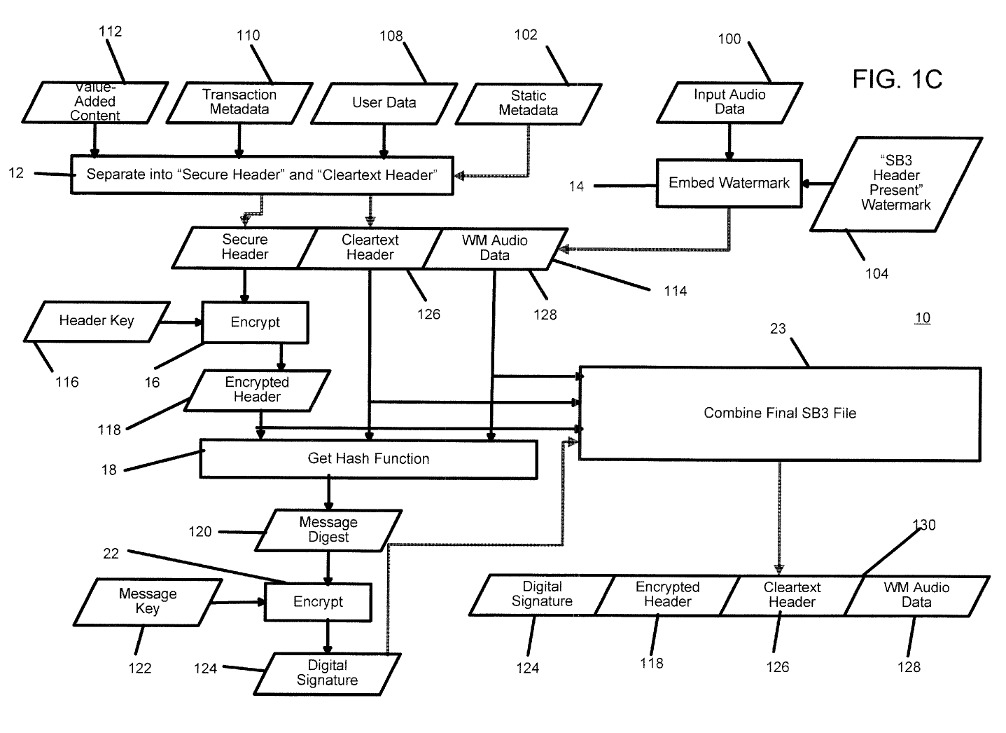

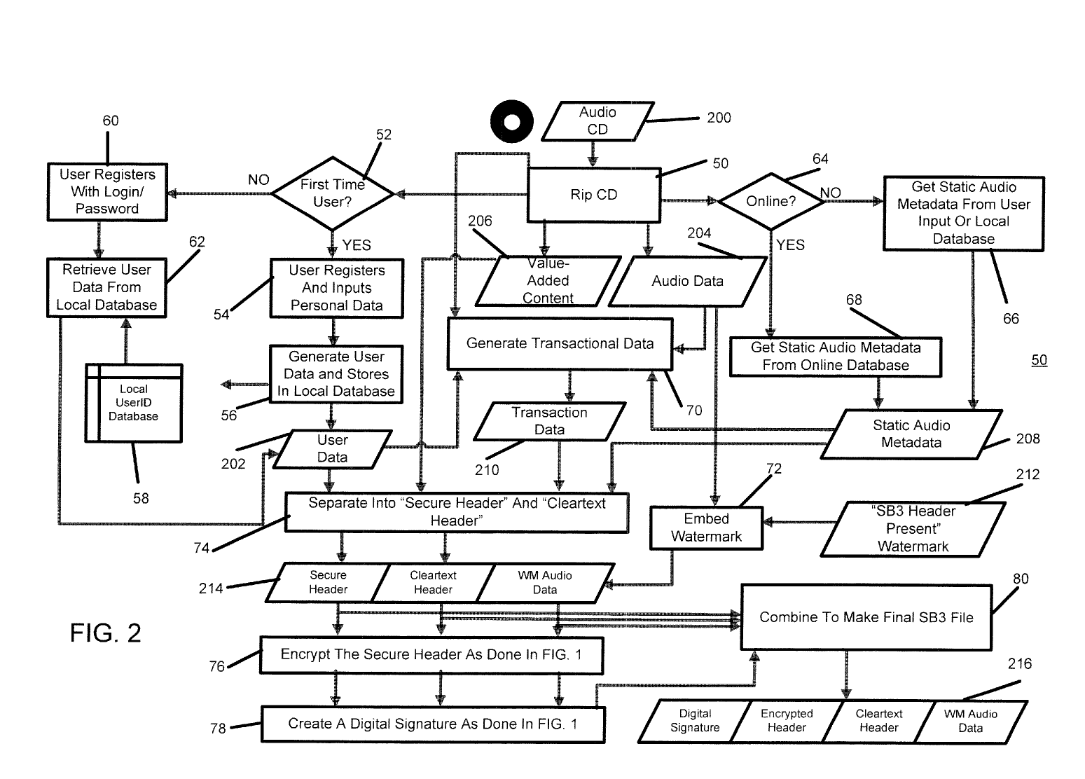

The structure of a conventional MP3 file is shown in FIG. 1A, in which a header is attached to the beginning of the MP3 compressed audio data file. The header usually contains static metadata describing the MP3 audio file, such as title, artist, album, year, genre in addition to technical attributes such as bit rate, sample rate, codec version, stereo mode, etc.

The SB3 file format is compatible with the MP3 header format, but also includes some additional information in its header, ranging from a few bytes to several megabytes, depending on the application. If a standard MP3 media player does recognize certain fields within an SB3 file, it will skip it and continue to play the audio. However, compliant SB3 media players will recognize the additional information and will operate accordingly.

The header for each SB3 file may contain several fields, such as certain static metadata fields that are associated with a particular song that a retailer sells. These fields may include one or more of the following:
Title, artist, album, year, genre, track number, cover art
Bit rate, sample rate, codec version, stereo mode
Content ID/recording information (as mentioned earlier, the recording/product/retailer information can also be embedded in a static watermark if there is an additional need for forensic tracking (e.g., if the header has been stripped), ISRC, Parental Control.
Product information: identifies the original distribution medium, such as electronic download, stream, CD, radio, etc.
Retailer: includes the name of the online retailer (e.g. Amazon).
User information: includes the UserId and or the user's e-mail address.

A method for preparing an SB3 file by a retailer in accordance with this invention is shown in FIG. 1C.

When the online retailer prepares a song to be downloaded to a particular consumer, he creates the various header information including the conventional static metadata 102, as well as additional information, including an SB3 “header present” watermark 104, as well as other additional transactional metadata fields such as:

User Data 108 pertaining to the particular user and purchaser may include information, such as:
a. Name of the user.
b. Email address of the user.
c. Date/time of the purchase.
d. A unique UserID that identifies the user. This UserID may be unique across all retailers, if it is possible to coordinate among various online retailers. Otherwise, the UserID will be unique only to a particular consumer at a specific online retailer.

Transactional data 110 may include information, such as:
a. A unique Transaction ID that identifies a particular copy of a particular song. This Transaction ID is combined with the all of the other information in the header and is stored in a centralized database (not shown).
b. Several web links that can guide a Compliant media player to web pages that can offer varied applications, such as streamed versions of the song, an online retailer to purchase additional songs, a website to redeem tokens, and many others, as will be discussed in the Value-Added Content and Services section.

In addition to static & transactional metadata, value-added content (“VAC”) 112, such as a ringtone or additional audio/visual data, can be dynamically inserted into the header of a particular file for a particular user. For further details, see the Value-Added Content & Services section.

The SB3 header is assembled (step 12). Its structure is illustrated in FIG. 1B.

In FIG. 1B it should be noted that a portion of the SB3 header data is encrypted, while another portion is not encrypted. The non-encrypted data, referred to herein as the “Cleartext Header”, is viewable by any conventional MP3 player. The encrypted header data, which is referred to herein as the “Secure Header”, can only be viewed by a compliant player that has the necessary decryption key to view the data. The system has the flexibility to determine if certain header data fields should be in the cleartext Header, the Secure Header, or both. It may be advantageous to include certain fields, such as a user's email address, in both the cleartext and secure headers. In this particular case, having the user's email address publicly viewable may have a deterrent factor. Additionally, by having the email address also in the secure header, enable another level of protection for this data. Other data fields may also be found in both the cleartext and the secure headers. These fields may include the retailer name, the type of media on which the content is originally recorded or transmitted to the user, tokens, etc. In addition, the audio file 100 is modified by embedding therein a watermark 104 (step 14) resulting in a watermarked audio file 128.

All the headers and the watermarked audio file are combined into an intermediate file 114 that includes the secure and cleartext headers and the watermarked audio file.

Header Security

Because the SB3 file keeps very important information in its header, it is vital to know whether the header has been altered at any point before it reaches the end-user.

When a retailer packages a file for delivery, the following steps are taken, as can be seen in FIG. 1C.
Using public key cryptography, one or more public/private header keys pairs 116 are generated by a central trusted authority (e.g. Verisign) for each legitimate retailer, including on-line retailers (e.g., Amazon) or physical retailers.
The secure header from file 114 is encrypted (step 16) to generate an encrypted header 118.
The retailer sends its public key(s) to all of its customers when they purchase an SB3 file.

The encrypted header 118 and the remainder of the intermediate file 114 are fed to a hash function generator to obtain a hash (step 18) that is used in a message digest 120.

Next, the message digest 120 is then encrypted (step 22) using a message key 122 to create a digital signature 124. The digital signature 124, the encrypted header 118, the cleartext header 126 and the watermarked audio data 128 are then combined to generate the SB3 file 130 (step 23).

Alternatively, steps 16 and 18 are combined and the hash for the message digest is generated by encrypting the whole intermediate file 114 using the header key and then applying the hash function to this encrypted file to generate the digital signature.

CD-Ripping Extensions:

A compliant media player could also have a CD-ripping application, which can produce SB3 files from a CD that have the same functionality as SB3 files purchased electronically online. While conventional CDs have no embedded watermarks, in the present invention, a CD that is used has an embedded watermark therein as described above “SB3 Header Present” watermark.

FIG. 2 shows such a method 50. In this method a compliant CD 200 is ripped by a compliant CD-ripping application (step 52). As part of step 52, a test is performed to determine if the user is using this application for the first time. If he is, then in step 54 the user registers the application and provides personal information to a central server (not shown), preferably online. In step 56, user data 202 obtained during the registration process is saved in a user data base 58.

If the user has registered before (step 52), then in step 60 he logs in using a user name and password. In step 62 the user data 202 is retrieved from the database 58.

The compliant application generates in step 50 the audio data 204 and the value added content 206 as part of the ripping process. The application also determines whether it has Internet access in step 64. If there is no Internet access, then the application obtains static audio metadata 208 from the user and/or a local data base (step 66). If there is Internet access (step 64) then the static audio metadata 208 is obtained from a remote source (step 68) such as Gracenotes. Alternatively the metadata is provided by the user.

In step 70, the various data is combined as transactional data 210.

In step 72 an SB3 Header present watermark 212 is embedded into the audio data 204. In step 74, the various data is combined into an intermediate file having a secure header, a cleartext header and a watermarked digital data. In steps 76 and 78 the secure header is encrypted and a digital signature is created, respectively, as in the apparatus and method of FIG. 1C. In step 80, the digital signature and the file 214 are combined to obtain a final SB3 file 216 having the same components as the file 130 in FIG. 1C.

The method creates SB3 files with the following characteristics:
The ripped SB3 files are playable on any MP3 player.
The ripped SB3 files are playable on any compliant media player.
The ripped SB3 files include the user's (e.g., Alice's) identifier, UserID (Alice) included in the file header, as well as other personal information. This will enable playback control for CD-ripped files within compliant players.
If a user illegally stripped the SB3 header that was ripped from a conventional CD, then the user can play the file on any compliant player. But, if a user stripped the SB3 header ripped from a newly watermarked CD, then a compliant player will not play the file.
The user will receive the same tokens for additional VACS as if the user had purchased the SB3 files electronically. Precautions will be taken to ensure that a single user (e.g., Alice) can only receive a single token for any given song from a CD. For example, even if Alice ripped her newly purchased CD ten times, she still only receives one token per song from the new CD.

If a non-compliant MP3 application is used to rip a watermarked CD, it creates MP3 files that could not be played on compliant media players (described below), since there would be no SB3 header present, but there would be the one-bit watermark embedded in the audio.

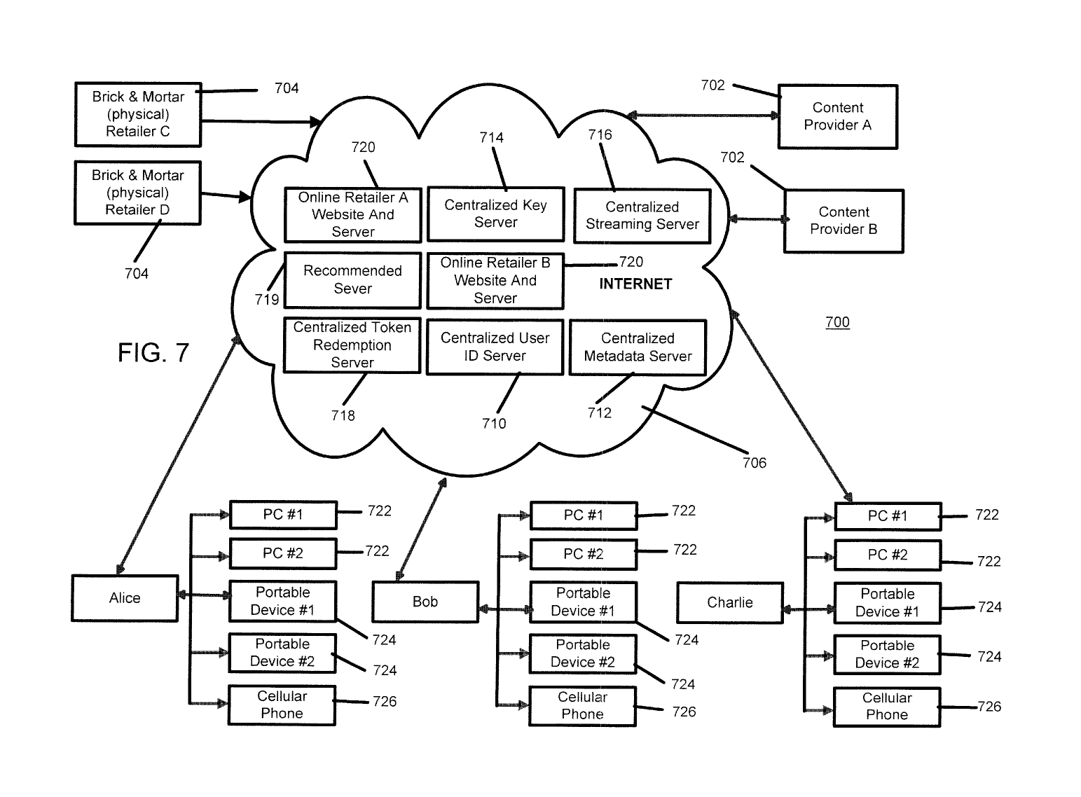

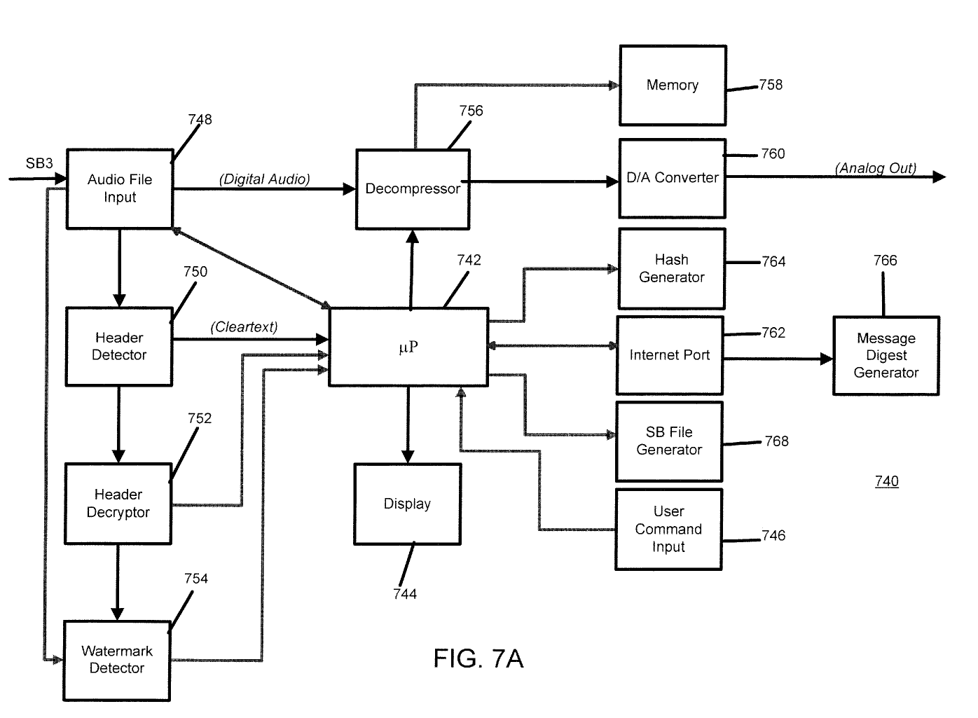

FIG. 7 shows a typical system in which the subject invention is practiced. The system 700 may include one or more content providers 702, one or more physical retailers 704, a distributed computer network 706 and a master server. The master server includes several elements such as centralized user ID server 710, a centralized metadata server 712, a centralized key server 714, a centralized streaming server 716 and a centralized token redemption server 718. In addition to the physical retailers, the system may also include one or more on-line retailers 720.

Finally the system includes several users such as Alice, Bob and Charlie. Each user may have one or more desktop PCs 722, one or more portable devices 724 and one or more cellular phones 726. Each of these devices are networked and incorporate a player that receive digital audio file such as an SB3 and selectively play back its audio data as a sound program. Some typical modes of operation are now described in conjunction with the Figures.

A block diagram of a compliant player 740 constructed in accordance with this invention is shown in FIG. 7A. This player 740 is incorporated into one or more devices 722, 724, 726. The player 740 includes a microprocessor 742, a display 744 for providing messages and other information to the user, and one or more user inputs 746, such as actual or virtual keys and/or a keyboard for receiving commands and other information from the user. The microprocessor is operated by software to perform the various functions described herein. The player 740 further includes a file input receiving either a compliant digital audio file SB3, or a conventional digital file. The player further includes a header detector 750, a header decryptor 752, a water mark detector 754, an audio file decompressor 756, a memory 758, a D/A converter 760, an Internet port 762, a hash generator 764, and a message digest generator 766. The various elements of the player are shown as discrete elements for the sake of clarity, it being understood that preferably the player is implemented by software either as an embedded player or as a standalone player and may have several formats, such as a widget, an application, a plug-in and a sidebar and may be incorporated into links associated with 3rd party websites such as blogger, Myspace, Facebook and other applications.

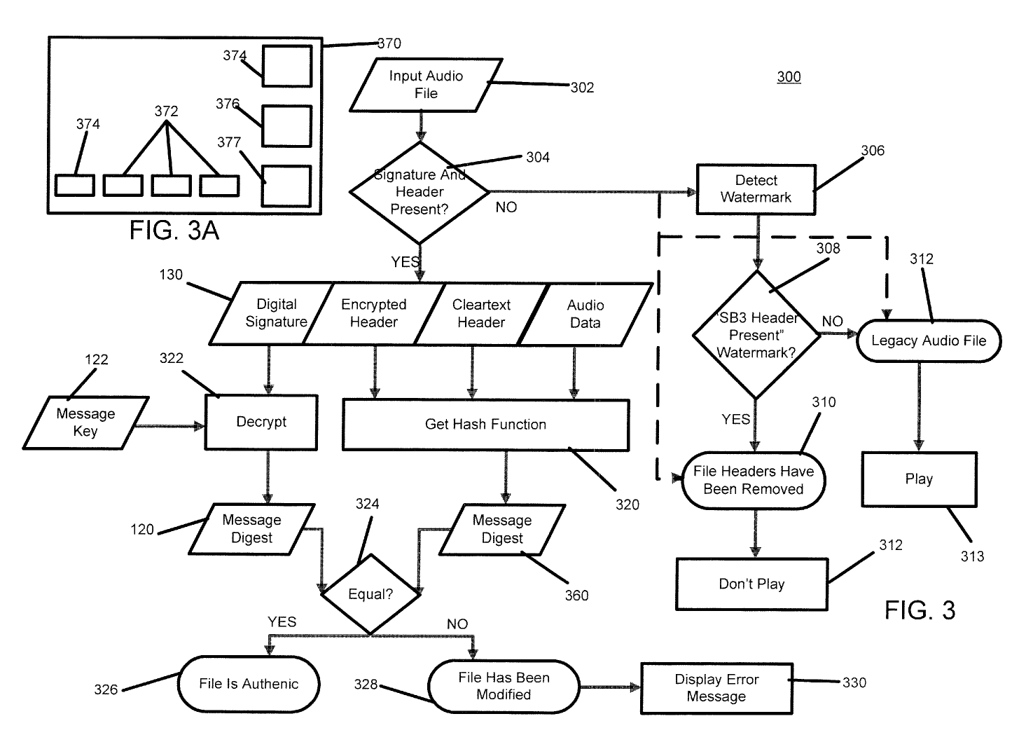

The operation of the player 740 is now described in conjunction with the flow charts of FIGS. 3, 4, 5, 7A and 8. When an SB3 file is received by a compliant player, such as player 740, the player first checks to see if the file is authentic. This process 300 is described in FIG. 3. A customer, e.g., Alice, downloads or imports an SB3 file from a content provider 702, a physical retailer 704 or an on-line retailer 720. The file is received by file input 748. Once an end-user (Alice) receives an SB3 file, the following steps are taken by the microprocessor 742, as can be seen in FIG. 3:
1. The microprocessor 742 in Alice's Compliant media player first checks to see if there is a SB3 header file present (step 304) using header detector 750.
   a. If there is an SB3 header present, move to steps 320 and 322 below.
   b. If there is not an SB3 header present, the microprocessor 742 checks to see if there is a “SB3 Header Present” watermark embedded in the file (step 306, 308) using the watermark detector 754.
      i. If a watermark is detected, the SB3 header was removed, and the file should not be played (step 312). In an alternate embodiment, the watermark is decoded to obtain the data embedded therein and compared with at least some of the information from the header (this information could be from either the encrypted portion, the cleartext portion, or both). If the information and data match, then the header can be considered genuine and the user can get access to the various VACS provided, as discussed below. If the information and data do not match, the header has been illegally modified or corrupted and no access to VACS is allowed.
      ii. If there is no “SB3 Header Present” watermark in the audio file, the file must be a conventional or legacy MP3 file, and should be played (step 310). The audio file is stored in memory 758 and/or decompressed by decompressor 756. In either case, the file can be played (Step 313). As part of this process, the decompressed audio file is fed to D/A converter 760 that generates corresponding analog signals that can be reproduced by two or more speakers (not shown).
2. The microprocessor 742 computes its own hash of the SB3 file 130 in step 320 (on hash mark generator 764) to get a computed message digest. The media player also decrypts the received digital signature from file 130, using the message key 122 (step 322) to generate a received message digest 360 (that should be identical to the message digest 120 in FIG. 1C) using message digest generator 766.
3. The microprocessor 742 compares the received message digest 120 with the calculated message digest 360 (step 324).
   a. If they are equal, then the microprocessor 742 is assured that no bit within the SB3 file had been altered and therefore the SB3 file is authentic (step 326) and it can stored and/or played and other functions can be performed therewith as described below.
   b. If they are not equal, then the microprocessor knows that the file has been modified (step 328) and presents a message on display 744 (step 330) to the user that the file has been altered, and it will not be stored or played.

All consumers that purchase content from a particular retailer, such as retailer 720, will use the same public key(s) to check the authenticity of their own headers. For example, if Alice and Bob buy files from retailer 720, they both use the same public key to decrypt the digital signatures of the received files. Alice may want to send a copy of an SB3 file to Bob, but there may be some information in Alice's SB3 header that she would not want Bob to be able to read. Additionally, an online retailer 720 may want certain information in the Secure Header of Alice's song that can only be read by Alice, for example, such as her credit card number. Therefore, there may be another level of encryption in the SB3 header that is unique for only Alice, and only she can decrypt. For example, the retailer may use one public/private key pair to secure the digital signatures of all its SB3 files, another public/private key pair to secure a portion of the Secure Header for all users, and then may use a different encryption key scheme to secure the remainder of the secure header individually for each end user.

This process of checking the hash to see if the file has been altered is called authentication. Authentication is not only important for detecting illegitimate changes in the file. If it can be verified that the SB3 file has not been changed, the consumer then knows that the SB3 file is an “authentic”, high-quality audio file from a reputable retailer. In some instances many illegitimate retailers may be selling poor-quality MP3 files. By displaying a small icon on the display 744 when a file is authenticated (similar to the yellow lock icon on a web browser when an authenticated web site is being visited), the user will know that the file is a high-quality, legitimate SB3 track versus an MP3 file from an unknown source with unknown quality.

FIG. 3A shows a typical image that is presented on display 744 of a compliant player 740. The image includes various standard controls 372 for playing the audio portion of an SB3 file, such as stopping, fast forwarding, rewinding, etc. Alternatively, the player may have discrete physical keys or other types of user inputs 746 that are used to receive commands and other information from the user. In addition, several hard or soft keys 374, 376, 377 that can be selected to activate a static or dynamic link or token from the header, or for initiating sharing content with others as described. Activating these keys may trigger a respective widget for the designated purpose. In one embodiment, a compliant player is adapted to open a side bar for display 744 that is used to display various information related to the digital content (e.g., title, artist, length, name of album, album artwork, etc.) The keys 374, 376, 377 can be part of the sidebar.

In an alternate embodiment, a file SB3 has no watermarking and a compliant player does not expect any. In this case, in the flow chart of FIG. 3, at step 304, if no signature or header are present, the microprocessor 742 assumes that the file is not authentic (step 312). Alternatively, the microprocessor assumes that the file is a legacy audio file (step 312).

Playback Control

The system enables users to send and share SB3 files with a small set of friends, up to a limit. Once that limit is reached, users cannot receive songs from any other people without paying for them. The process of sending entire SB3 files to friends is a separate functionality from the ability to send a friend a link to a streamed, preview version of the song, which is described below in the “Music Sharing” section.

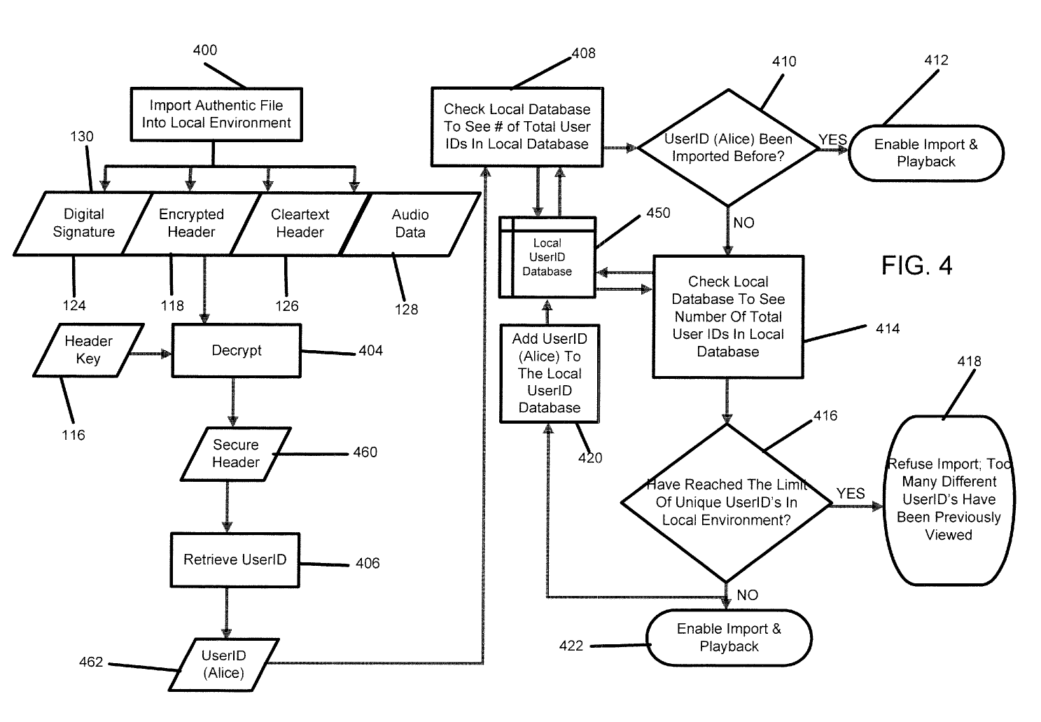

The process 400 for playing an SB3 file received from another customer, and not directly from a retailer, is now described in conjunction with FIG. 4. When a user (e.g., Bob) receives a new SB3 file 130 from another user (usually, a friend, e.g., Alice) on a compliant media player, encrypted header 118 is first decrypted using the header key 116 (step 404) by header detector 750 (FIG. 7A). A user ID 462 is then extracted from the resultant secure header 460 (step 406). This user ID identifies the other customer from whom the SB3 file has been obtained. In step 408 a local database 450 is checked to determine if other SB3 files have been received from the same user (Alice). A decision is then made (step 410) whether files have been received from the same user before. If the answer is ‘yes’, then in step 412 the player is enabled and allowed to proceed with playing the digital audio file in a normal fashion. If this is a new file source, then in step 414 a number M is retrieved from the local database 450 indicating the number of users that have provided an audio file to Bob. A compliant player or the compliant players of a given customer that are sharing the same local UserID database 450, in one embodiment, is/are allowed to receive and play back audio files only from a predetermined number N of other customers. N may be for example, five.

Therefore, in FIG. 4, in step 414 the number M is retrieved from database 450. In step 416 a check is performed to determine if the threshold N has been reached. If M=N, then the microprocessor 742 refuses to play the file and an appropriate message is presented to the user (Bob) in step 418 on display 744. If M<N, then in step 420 Alice's UserID is added to the database 450 and M is incremented by 1. In step 422 the player is enabled and allowed to play the audio data 128.

More specifically, all of the SB3 files that Alice had purchased have her UserID (Alice) within the headers. Similarly, Bob has his UserID (Bob) inside of the header of all the SB3 files he has purchased. Alice can send Bob her purchased songs, and now Bob has a unique UserID in database 450 (in addition to his own). If the system has set a limit of five unique users, Bob can receive purchased content from four more friends before his compliant media player stops him from receiving content from anyone else.

Watermark Extensions:

As mentioned earlier, certain information may be included from the secure and/or cleartext headers in an in-band watermark, which offers some amount of forensic ability to trace the origin of an illegally modified file. In the example below, the content owner includes the RetailerID in an audio watermark (which identifies the retailer who sold the file), and a retailer includes an individual consumer's UserID in the watermark just before it is sold and distributed (which identifies which user purchased the file). Ideally, the retailer and the content owner generate and insert the watermarks using the same technology. But, there may be cases where one technology is used by the content owner to generate and embed the retailer ID watermark, and a separate technology is used by the retailer to generate and embed the he UserID watermark in the file.

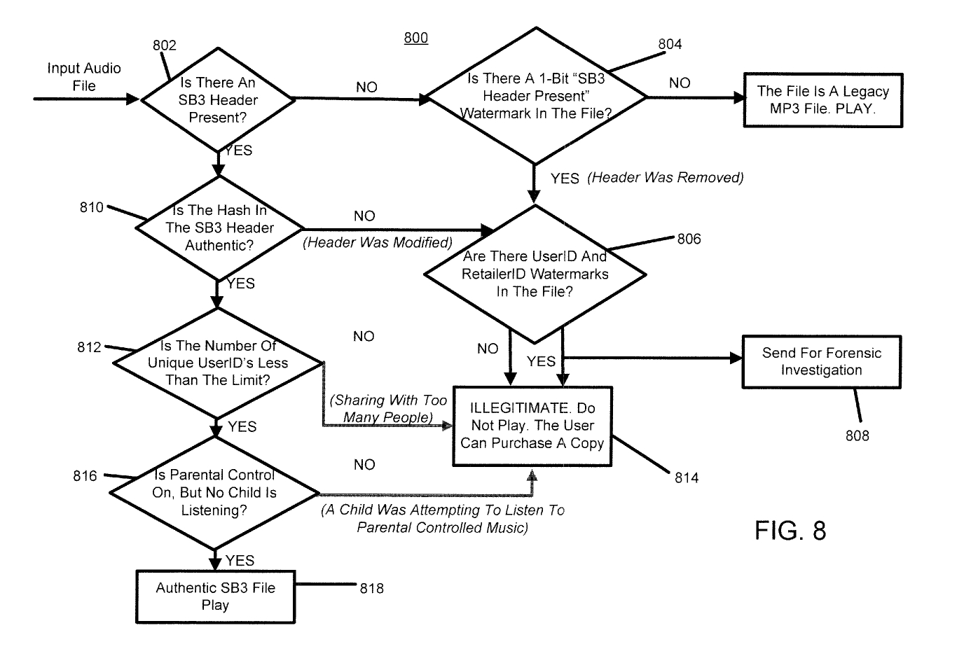

As can be seen in FIG. 8, the system first checks for the presence of an SB3 header (step 802). If an SB3 header is not present, it checks for the 1-bit watermark (step 804). If there were a 1-bit watermark, but no SB3 header present, then someone must have illegally removed the SB3 header from the watermarked file. The system retrieves the UserID and RetailerID watermarks from the audio data (step 806) and sends this information to a central server for further forensic testing (step 808). The system further generates the hash corresponding to the digital signature (step 810) and then authenticates the same. If the hash is not authentic, then the file received (or at least its header) has been modified. This information is also supplied to the central forensic investigation.

If the hash is authentic then in step 812 a test is performed to determine whether the number of allowable users (e.g., sources of files) has been exceeded. If it has, then in step 814 a message is presented to the user that the file is not valid and the audio data is not played.

If in step 812 it is found that N has not been exceeded then the system goes to step 816 to determine if the adult control flag for this file is on. If it is not on, then the SB3 is playable and the compliant player is enabled (step 818). If in step 816 the adult content flag is on a further test is performed to determine if a child is operating the device. There are several known techniques to make this determination, including, requesting a credit card. If it is determined that the user is a child, a message is again presented that the file will not be played (step 814).

Value-Added Content and Services

The SB13 can also include optional value-added content and services (VACS) that are bundled with the file and are preferably compelling enough that users would be willing to switch to compliant media players (that have some playback limitations) in order to receive it. The value-added content can be stored within the header itself (e.g. additional songs, ringtones, videos, coupons), or the VACS can be referenced by web links that are stored within the SB3 header.

Preferably, the SB3 header uses the ID3v2 header format, which is the widely used MP3 header format for all the major MP3 media players (e.g. Windows Media Player, iTunes, Winamp). In the event that SB3 uses a different audio compression format (e.g. MPEG-AAC), SB3 can still use the same header format of that audio compression format (e.g. ADTS). If a legacy, non-compliant MP3 player tries to play a SB3 file that contained 2 MB of secured value-added content in its header, the MP3 player simply skips over this 2 MB of data since it cannot handle the security of the content, as is specified in the ID3v2 header format that most every major MP3 decoder uses. The ID3v2 header is flexible enough to hold up to 256 Mbytes, although the available memory resources of particular MP3 decoder implementations may practically limit the size of eventual SB3 headers.

As discussed, value added content and services can be provided either directly in the SB3 header or indirectly via secure web links

Music Sharing

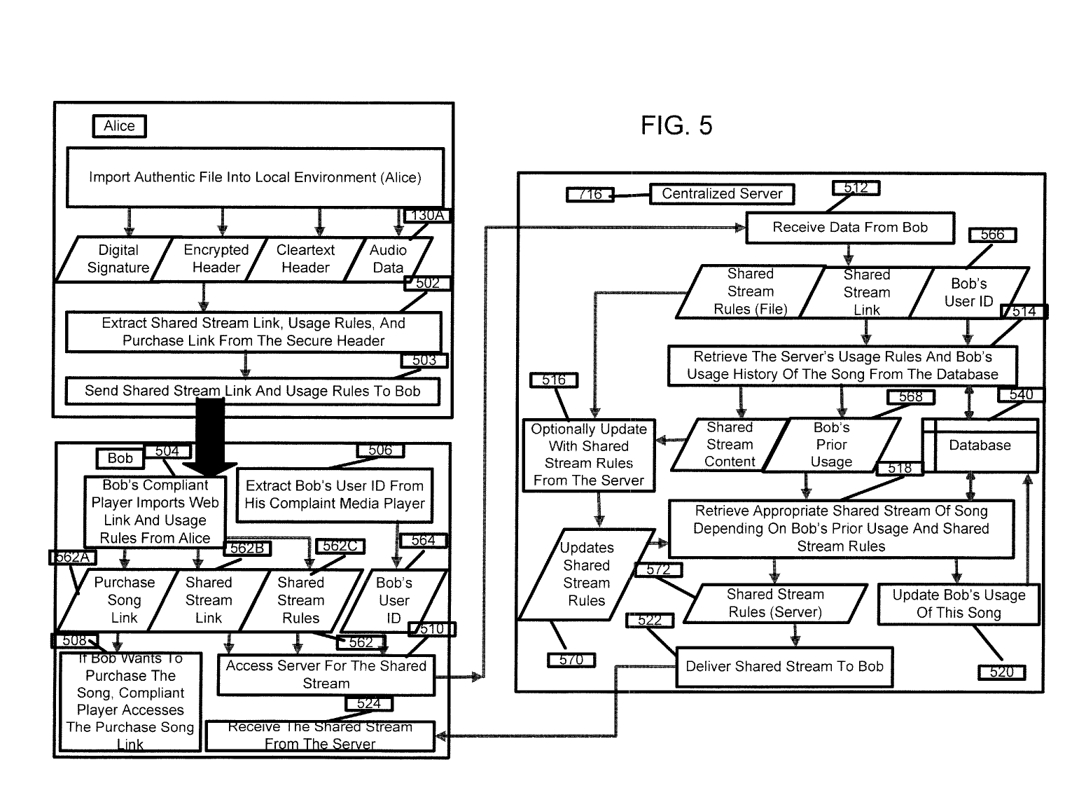

One value-added service that many consumers desire is the ability to share their content with their friends. Suppose that Alice has just purchased a song, and she wants to share it with her friend, Bob. As described above, one way she can do this is by sending the corresponding SB3 file. Another method is presented here. According to this embodiment, inside the secure portion of the header of Alice's SB3 file, there are several web links that are securely sent to Bob's compliant media player. Once such link could point to a centralized server 716 (FIG. 7) that hosts a stream of the song Alice just downloaded. Alternatively, the centralized share can point to a link to access another site that provides the respective stream. Alice can send Bob this link by selecting an appropriate button such as 377 on FIG. 3A, which would enable him to stream a version of Alice's song (a “Shared Stream” link) from the centralized server 716 to his compliant media player. Another link (a “Purchase Song” link) points towards an online retailer 720 that Bob would use if he wanted to purchase the song for himself. This process is now described in conjunction with FIG. 5. Bob's compliant media player could be within any of his networked devices, including his cell phone 726, an application on one of his standalone PCs 722, or it could be a widget embedded application within his social network profile web page.

As shown in FIG. 5, Alice receives an SB3 file 130A which has been authenticated as discussed above. Embedded in one of the fields of the header, for example in the encrypted header, there is a VACS field 562 constituting value added content and services in the form of one or more links, such as a share link, a purchase link and a set of rules determining the usage of these links. This field is extracted in step 502. Information is also presented to Alice to indicate to her that she can share an audio file as either a streamed digital file or as a purchase opportunity. For example, a button 374 may appear on the player screen (FIG. 3A) with the legend SHARE to indicate this available option to Alice.

When Alice selects or activates button 374 (step 503), the data field 562 is transmitted to Bob's player as part of an e-mail, IM, blog, widget or other similar electronic means. The field is received in step 504.

Once the field 562 is received, Bob is provided with one or more options, for example, on the screen of his player (not shown). One option is for Bob to purchase the song just heard or purchased by Alice. If Bob selects this option (step 508), his player, or other device contacts the website of the retailer identified by the information from Alice as a purchase link 562A. The link 562A may be a direct or an indirect link. Bob's device then performs the purchase from retailer 704 or 720 and a new file SB3 is sent to Bob. Bob can now play the purchased file anytime on a compliant or legacy player.

Alternatively, if available, Bob selects the share stream option. In this case, in step 506, Bob's user ID 564 is retrieved. In step 510 the stream server identified by its link 562B is accessed with a request for the content flagged by Alice and (optionally) Bob's user ID, and the share rules 562C. The stream server 716 receives this request in step 512. In step 514 the server retrieves from a local database 540 its own usage rules together with Bob's past history (data field 568 from local database 540. Alternatively, Bob may listen to the stream even if he has not registered and therefore his past history is unknown. In step 516 the server rules and the stream rules 562 are compared and correlated to create updated share rules 570.

Next, in step 518, the appropriate shared version of the digital audio data is obtained from server 716. In step 520 Bob's data record is updated and sent to the database 540.

Next, in step 522 the shared data content 572 are selected based on the request and the mentioned rules and are delivered to Bob. Bob receives the content and plays it (Step 524). Depending on the rules and many criteria set by the retailer or content provider, the content is a short clip of the respective performance, the whole digital audio content, commentary by a well known commentator, etc.

In one embodiment, the whole process shown in FIG. 5 is subject to playback rules as described above in conjunction with FIG. 4. That is, if Bob has previously shared content with four others, the process of FIG. 5 may not even start. Of course, if Bob is using a legacy, non-compliant MP3 player, he is not being subjected to any playback control rules.

The goal of embedding “Shared Stream” links in SB3 files is to make it very easy and quick for users to legally share content with each other. Users do not have to move multi-megabyte files around via email or p2p networks; rather, they can easily choose the names and addresses of their friends from within their compliant media player, as well as the songs they want to share.

In addition to the shared stream link, there would also be a set of rules (set by the content owner of the purchased song) in Alice's header that would dictate how the shared stream can be rendered. This set of usage rules would be sent from Alice to Bob, in conjunction with the Shared Stream link. For example, the rules could state that the Shared Stream to be heard by Bob will be limited to only a 30 second segment of the original song. The rules could alternatively state that Bob can freely listen to the full length of the original song up to ten times, or an unlimited amount of times during the next five days. The centralized server 716 that hosts the shared stream 522 for Bob can also have its own set of rules set by the content owner that may compliment or modify the rules set in the file purchased by Alice. This enables the content owner the flexibility to modify the allowable rules for the Shared Stream after the time that Alice had purchased her original song.

The system can ensure that Bob correctly follows the correct usage rules even if multiple friends send him a Shared Stream from the identical song, purchased from different retailers, and Bob listens to the song from multiple compliant media players. For example, suppose Alice purchased the new Beyonce song from Amazon and sent Bob a link such that he could hear a shared stream version of it. The content owner set usage rules that the shared stream version of the new Beyonce song could be listened to for ten times at full length. After the tenth play, Bob could only hear a 30-second clip. The centralized server 716 that hosts the shared stream sent to Bob keeps track of how many times Bob has heard this new Beyonce song. During the next week, Bob listens to the full length of the shared stream of Alice's Beyonce song, a total of ten times, from three of his different compliant media players. On the eleventh time Bob asks to hear the same song, the server knows that Bob has already surpassed his allowable ten full-length plays, so the server sends Bob a 30 second version instead. Two weeks later, Charlie buys the same Beyonce song that Alice had purchased. Charlie purchased the song from Google instead of Amazon. Charlie sends Bob a link to his new Beyonce song, as well as the usage rules, which are identical to the usage rules in Alice's copy of the Beyonce song. When Bob asks to listen to Charlie's version of the Beyonce song, the centralized server realizes that Bob has already listened to the same Beyonce song (from Alice) ten times, so he will only be able to hear the 30 second version of the song, whether he clicks on Alice's or Charlie's Shared Stream link of the Beyonce song. If content owner chooses to, perhaps because Bob has purchased a lot of songs recently and the content owner wants to reward Bob, the usage rules of the shared stream of the Beyonce song can be updated at the centralized server to enable Bob another ten full-length streams of the Beyonce song.

It should be noted that preferably, in order to access a shared stream, every compliant media player must access the same centralized server (or constellation of distributed servers) that hosts the streams. This centralized server knows the User ID of the consumer using the compliant media player, and how many times (and for how many days) any particular user has listened to any particular shared stream. This assumes that a single consumer (Alice) uses the same User ID across retailers and compliant media players. Also, all copies of the same song (e.g. the new Beyonce song), independent of the retailer that sold the song, has the same shared stream link that points to the same centralized server, and they all have the same usage rules that were set by the content owner. If Alice had a different User ID at different retailers, the centralized server could adjust accordingly.

If a user were to strip the header from an SB3 file, then the user would not be able to share the song as a shared stream with any other users. While a user could email the entire SB3 file to another user, which can still be played on a legacy, non-compliant MP3 players, the intent is that sharing with compliant players would be much simpler, more flexible, and better integrated within their compliant media players.

While receiving an audio stream, Bob is also presented the option to purchase the song. Once Bob purchases a song (from one of the retailers-step 508) he may have several options. One option is to allow Bob to stream (but not download) by the full length of the song for an unlimited number of plays for an unlimited amount of time. Another option is to create a downloadable SB3 file, with a header specific for Bob. Bob's compliant player obtains the purchase song link 562A from file 562 containing the Beyonce song originally sent by Alice, accesses the online retailer, provides appropriate payments and receives a new SB3 file.

The centralized streaming server 716 tracks how many songs that Alice shares with her friends and it may also track how many songs were eventually purchased as a result of Alice's sharing. Alice may choose to publicly display the number of tracks that she has shared and purchased, since a high number of either may publicly designate her as a “tastemaker”. Alice may be rewarded with free content and/or services for being a tastemaker. For example, when a sufficient number of Alice's friends buy a specific song, Alice gets a token as described in more detail below.

Preferably, the shared stream link 562B and the purchase song link 562A are securely stored within Alice's SB3 header and securely transferred to Bob's compliant media player. If the links within the header of an SB3 file are not securely attached, then an unscrupulous user could substitute the initial retailer web links with links that point to spam web sites, viruses, or other undesirable and/or harmful content. Since the web links are embedded in Alice's authenticated header file, Bob knows that he can trust anything from Alice as being authentic, legitimate and safe links to music. Bob must also use a compliant media player to receive the web links in order to ensure that the links are secure during transmission.

In addition to the shared stream link 562B and the purchase song link 562A, a number of other secured links may be included in the SB3 header for various purposes, such as a web site that can push shared stream links for recommended songs based on the user's preferences, friends' preferences or the user's purchasing history or a web site dedicated to the artist on the SB3 file.

The various links mentioned herein (including any purchase, shared stream, recommendation links, etc.) could be either static or dynamic. Static links are set at the time or prior to delivering them to a user. Dynamic links are links that may be changed after the respective file has been sent to a user. In this latter case, the dynamic link points to a location of a respective centralized server. The actual address of the content or VACs is stored at the server and can be changed by the content provider, retailer, etc., at will.

In another embodiment of the invention, a recommendation server 719 is provided that either stores or has access to various programs and other contents. The recommending server 719 is accessible by a static or dynamic link and this link is incorporated into the heading of the SB13 files. When a user, e.g., Alice, obtains an SB3 file, another button is presented on the display 370 to show that recommendations are available. When Alice activates this button, a message is sent by her compliant player to the recommending server 719 with various information, such as the content file that Alice has just purchased, the titles or genre of other digital files stored in the player memory and other similar data indicative of Alice's preferences. Based on this information the recommending server selects other similar programs or digital content and sends these to Alice. These recommendations may be yet other links from which Alice can download the recommended contents, get reviews of the contents, shared links, get small clips of the contents, etc.

Tokens:

The present invention also involves distributing tokens to the users. These tokens entitle one or more users to additional materials including various goods and services as a reward for being good customers. Preferably, these tokens are provided as part of an SB3 file. For example, a purchased SB3 file can also act as, or include a token, which can be redeemed and collected to receive such value-added content and services (VACS) as free ringtones, free songs, actual products tied to the content (e.g., mugs or t-shirts bearing a picture, a logo and/or the title of a song) or access to a free interactive music service.

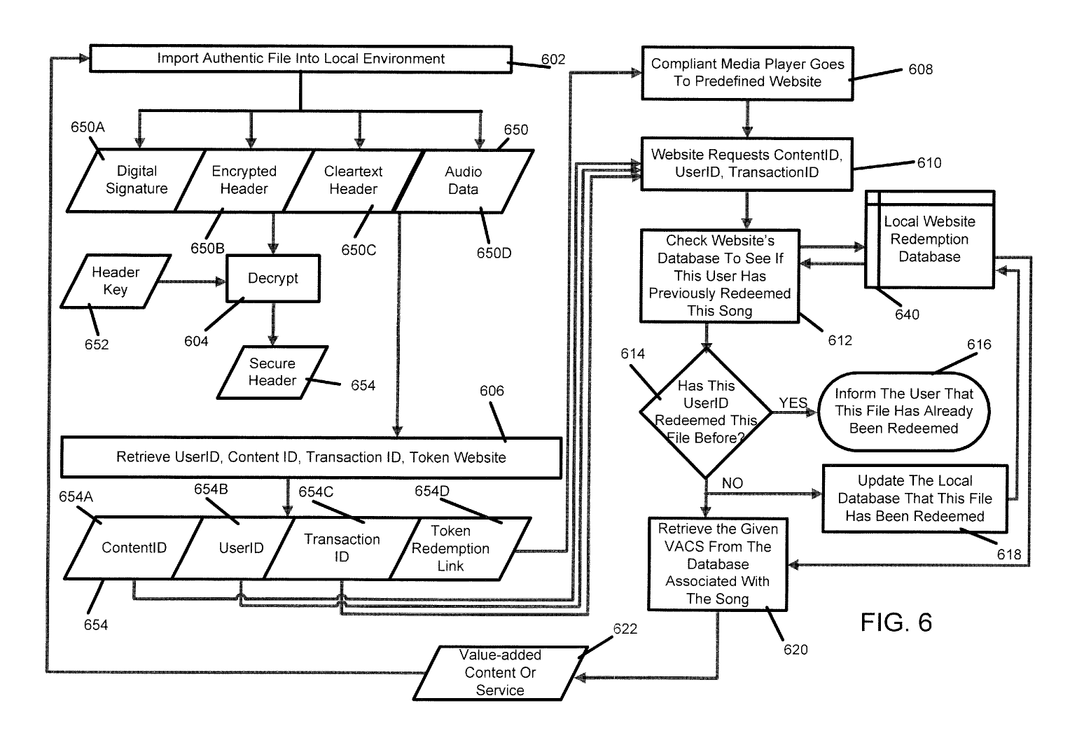

This aspect of the invention is illustrated in FIG. 6. In this Figure, Alice purchases a new Beyonce song with an SB3 file from a retailer, such as Amazon. In other words, Alice imports or otherwise downloads file 650 in step 602. As in previous processes, the file 650 includes a digital signature 650A, an encrypted header 650B, a cleartext header 650C and audio data 650D that can be played as the new Beyonce song. The encrypted header 650B is decrypted in step 604 using a header key 652 to obtain the secure header file 654. In step 606, Alice's compliant player retrieves a file 654 including a content ID 654A identifying the digital audio file, Alice's userID 654B, a transaction ID 654C and a token redemption link 654D. Thereafter, or alternatively, when Alice plays the song for the first time, on the screen of the player a button 376 appears that indicates to Alice that she may be entitled to a token.

Alice can activate the button 376 to access a token redemption service 718, preferably through her compliant player. When Alice activates button 376 in step 608 a contact is established with the token redemption server 718 which may be operating as a website with a URL address identified by the token redemption link 654D. In step 610, the server requests various information identifying Alice and her SB3 file, such as the Content ID, the UserID, TransactionID, etc. The compliant media player securely sends the respective fields to the server 718. The server checks with the centralized UserID server 710 that Alice is bone fide user (step 612). The server also checks with other databases, such as the metadata server 712, and/or its internal database 640 whether Alice or the respective SB3 file is associated with, or is entitled to a token corresponding to any VACS based either on ContentID or the TransactioniD, or some other criteria. For example this particular copy of the given Beyonce song may have been issued with a token that entitles Alice to streaming video of the same song or a different song.

Next, if Alice is entitled to a token, the server checks if Alice has in fact redeemed the token before (step 614). If not, the token redemption server retrieves the appropriate VACS and delivers it to Alice's player (step 620). Alice can then take advantage of the VACCS (step 622). In addition, the website updates its database (step 618), such that this particular SB3 song that Alice purchased can never be used again to redeem a token. If in step 614 it is determined that Alice has used the token, she receives a message (step 616) indicating that she is no longer entitled to the token. If Alice then emails a copy of her purchased (and previously redeemed) Beyonce SB3 file to Bob, Bob will not be able to redeem the token within the song. If he attempts to do so, the token redemption website will recognize the SB3 file, identified by its ContentID and TransactionID, and recall that Alice already redeemed the token. There are many potential applications for tokens, for example:
1. For each SB3 file that Alice purchases, she will receive a token; after she purchases nine SB3 files, and accumulates nine tokens, she can exchange the tokens to download a free SB3 song.
2. If Alice buys ten SB3 files in a given month, she gets 30 days free usage of a premium music subscription service.
3. If Alice buys at least three SB3 files a month, she can use an interactive radio service for free for 30 days.
4. If Alice buys at least five Beyonce files, she gets access to a VIP section of Beyonce's website with certain content available only to compliant users.
5. Each token may entitle Alice to more than one product or service. For example, the token may indicate that Alice is entitled to five new songs, a t-shirt, a poster, a mug and a free membership to a fan club for a month. When Alice receives the file with the token, she is presented with a list of these goods and services. She is then given the opportunity to redeem either all the goods and services at once, or she may elect to redeem only some of them. When she shares the respective SB3 file with others, the token can be set up so that she can keep it and not share it with others. Alternatively, she can share the tokens with others. In this later case, the redemption server 718 keeps track of which goods or products have been already redeemed for a particular token. Each subsequent user is then allowed to redeem only the goods or products that have not been redeemed by previous users.
6. The actual goods and services associate with a token may be changed even after the token has been sent to Alice. For example, in step 612 an additional check could be performed to see if the goods and/or services have been changed, and the new goods and services can be presented to Alice. Thus, Alice can buy a song by Beyonce in February and if she waits to redeem her token in May, she may get a notice that she is entitled to a poster of a Beyonce show that has been published in April.

Value-Added Content:

As described above, the value added content and service are made available to users through a link embedded in the header. In another embodiment of the invention, in addition to services offered by linking to sites referenced in the SB3 header, it is also possible to include value-added content within the SB3 header itself, in a manner that is compliant with the requirements of ID3v2 tagging system. Preferably this value-added content is encrypted within the secure header portion of the SB3 file, and it can only be viewed by compliant players with the appropriate header key (as seen in FIG. 1C). Theoretically, an MP3 ID3v2 header can included up to 256 Mbytes of additional content. But as mentioned earlier, there may be limitations to the size of the SB3 header, since SB3 files must be backward compatible with all MP3 decoders currently in use, and not all current MP3 implementations may be able to support such large headers.

Other value-added content that can be stored directly in the SB3 may include:
1. Increase the audio quality of the purchased 128 kbps file to 192 kbps: the incremental 64 kbps is securely stored in the header, and is combined by a compliant player with the 128 kbps file at the time of playback. Non-Compliant players can not have access to the higher audio quality version.
2. Expand a standard two-channel audio file to a 5.1 channel version. The data for the additional 3.1 channels is securely stored in the SB3 header, and can only be combined by a compliant player with the two channel version at the time of playback. Non-compliant players do not have access to the 5.1 channel version, and can play the two channel version.
3. The SB3 file could include the lyrics, a ringtone, a music video and/or cover art for the purchased song in the secured portion of the header.
4. The SB3 header could include additional DRM-secured versions of additional audio files. These DRM-secured files, unlike the non-encrypted MP3 audio data in the SB3 payload, can only be played in compliant players. These DRM files may have similar rules to the Shared Streams, as discussed earlier, such that they can only be played a certain number of times, or for a limited amount of time.

The benefit of having content already available in the header is that all the value-added content is already available to the user once the SB3 file is purchased. The user does not have to be online to redeem the tokens. In addition, VACS can be presented to the end user before such redemption sites may be operational.

The present description of the invention generally referrs to the content within each SB3 file as being a digital audio file or clip. Of course the SB3 file can also contain video files as well.

Numerous modifications maybe made to this invention without departing from its scope as defined in the appended claims.

I claim:

1. A method of distributing content to users from a server using a distributed network comprising:
providing a digital file including digital content and a header, said header partitioned into two portions, a cleartext portion and an encrypted portion, said header including information uniquely identifying said digital file;
transmitting said digital file over said distributed network to one of said users to allow one of said users to receive said digital file and present said digital content to said one user.

2. The method of claim 1 wherein said digital file is provided in response to a transaction with said one user, said header including transactional data related to said transaction.

3. The method of claim 2 wherein said header includes user information is one of a userID, a user e-mail address and transactional data.

4. The method of claim 1 further including inserting a watermark in said digital file indicating that said header is present.

5. The method of claim 1 further comprising providing said digital file with a share control parameter incorporated into said header to allow said one user to share data related to said digital content with other users in accordance with said share control parameter.

6. The method of claim 5 further comprising monitoring of sharing of files between users using a share server.

7. The method of claim 5 wherein each user is allowed to receive content from a predetermined number of other users.

8. The method of claim 1 further comprising providing a token in said heading, said token being indicative of at least one of added content and added service that is available to one of said users.

9. The method of claim 1 further comprising providing a link in said header, said link providing the address of a content server that can provide one of additional content and services to the users.

10. A method of processing a digital file by a user, the digital file having a header including information uniquely identifying said digital file, and digital content, said header having an encrypted portion comprising:
storing or presenting said digital content;
detecting said header; and
in the presence of header providing said user with additional material including at least one of additional content, products and services.

11. The method of claim 10 further comprising decrypting said encrypted portion.

12. The method of claim 11 wherein a watermark is provided in said digital file, further comprising checking for said watermark if said header is not detected and inhibiting the presentation of said digital content.

13. The method of claim 12 wherein said digital content is an audio clip and said watermark is an audio watermark.

14. The method of claim 10 further comprising generating a modified header identifying a second user and sending said modified header.

15. The method of claim 10 further comprising receiving said digital file from another user.

16. The method of claim 15 wherein said user is limited to receiving digital files from only a predetermined number of other users.

17. The method of claim 16 wherein said user is limited to receiving a different content if said predetermined number of users has been reached.

18. The method of claim 17 wherein different content includes one of an abbreviated form of said digital content, an altered digital content that includes commercial advertising and a stream version of the digital content.

19. The method of claim 10 wherein said header includes a link, said link being one of a dynamic and a static link.

20. A method of distributing digital content files to users from a server using a distributed network comprising:
providing a digital file including digital content and a header, said header partitioned into two portions, a cleartext portion and an encrypted portion, said header including information uniquely identifying said digital file;
transmitting said digital file over said distributed network to a device associated with one of said users to allow said device to present said digital content to said one user and to allow said user to share said link with another user, wherein said other user can receive said content through said link.

21. The method of claim 20 wherein said digital file is provided in response to a request, said request includes an identification of said one user.

22. The method of claim 21 wherein said request includes information indicative of preferences of said one user.

23. A method of distributing digital content files to users from a server using a distributed network comprising:
providing a digital file including digital content and a header, said header including token providing a recipient with information related to additional material associated with said digital content;
transmitting said digital file over said distributed network to one of said users to allow said one user to play said digital content and to redeem said token by said one user for additional material.

24. The method of claim 23 wherein said token is redeemed for additional material.

25. The method of claim 24 wherein said token corresponds to additional content, several articles and services, further comprising sharing said digital file between several users, each user being allowed to redeem at least one of said articles and services through said token.

26. A device for playing digital content to a user comprising;
a receiver receiving a digital file including a header including information identifying additional material and received digital content, said header including an encrypted portion;
a microprocessor adapted to detect said header; and
a content presenter that is enabled to present said received content to the user, said content presenter being further enabled to present an indication to said user that additional material is available if said header is detected.

27. The device of claim 26 further comprising a watermark detector to detect a watermark in said digital file, said content presenter being prevented from presenting said indication if said watermark is present and no header is detected.

28. The device of claim 26 wherein said content presenter presents said content if said header is missing said encrypted portion.

29. The device of claim 26 further comprising a share selector activated by a user to share content with another device.

30. The device of claim 26 wherein said receiver is adapted to receive content from one of a central server and other users.

31. The device of claim 30 wherein said receiver is permitted to receive content only from a limited number of other users.

32. A computer readable software embedded in a medium that can be executed sequentially by a microprocessor to perform the steps of;
receiving a digital file including a header having an encrypted and a cleartext portion, and digital content;
Detecting if said digital file has said header;
If no header is detected, then processing said digital file as a conventional file;
If a header is detected then presenting an indication to a user that additional materials are available from the digital file.
